(19) United States
(12) Patent Application Publication
(10) Pub. No.: US 2019/0009863 A1
(43) Pub. Date: Jan. 10, 2019

(54) MODULAR HINGE AND LATCH SYSTEM FOR BOAT TOWERS

(71) Applicant: Diamondback Wake Products, LLC, Cocoa, FL (US)

(72) Inventor: Stephen ABOUD, Cocoa, FL (US)

(21) Appl. No.: 15/863,384

(22) Filed: Jan. 5, 2018

Related U.S. Application Data
(60) Provisional application No. 62/442,608, filed on Jan. 5, 2017.

(51) Int. Cl. B63B 21/56; F16C 11/10

(52) U.S. Cl. CPC B63B 21/56; B63B 35/815; F16C 11/10

(57) ABSTRACT

Boat towers having a lower portion fixed to a boat, an upper portion pivotally coupled to the lower portion, and a hinge configured to couple the upper portion to the lower portion are disclosed. The hinge may include a stationary portion coupled to the lower portion of the tower; a moving portion coupled to the lower portion at a hinge axis; an assisting device extending from a position fixed on the stationary portion to an interface on the moving portion; a catch coupled to the moving portion; and a latch coupled to the stationary portion configured to interface with the catch thereby locking the hinge in a closed position. The latch may be configured to move to a locked position by the moving portion moving into the closed position and the weight of the upper portion of the tower provides sufficient force to engage and lock the latch.

### CROSS-REFERENCE TO RELATED APPLICATIONS

This application claims priority to U.S. Provisional Patent Application Ser. No. 62/442,608, titled Modular Hinge and Latch System for Boat Towers filed on Jan. 5, 2017.

### BACKGROUND

The present disclosure relates hinge and latch devices. More specifically, the present disclosure relates to hinge and latch devices for use with boat towers.

### SUMMARY

Some embodiments relate to boat towers having a lower portion fixed to a boat, an upper portion pivotally coupled to the lower portion, and a hinge configured to couple the upper portion to the lower portion. The hinge includes a stationary portion coupled to the lower portion of the tower; a moving portion coupled to the lower portion at a hinge axis; an assisting device extending from a position fixed on the stationary portion to an interface on the moving portion; a catch coupled to the moving portion; and a latch coupled to the stationary portion configured to interface with the catch thereby locking the hinge in a closed position. The latch may be configured to move to a locked position by the moving portion moving into the closed position and the weight of the upper portion of the tower provides sufficient force to engage and lock the latch.

### BRIEF DESCRIPTION OF THE FIGS.

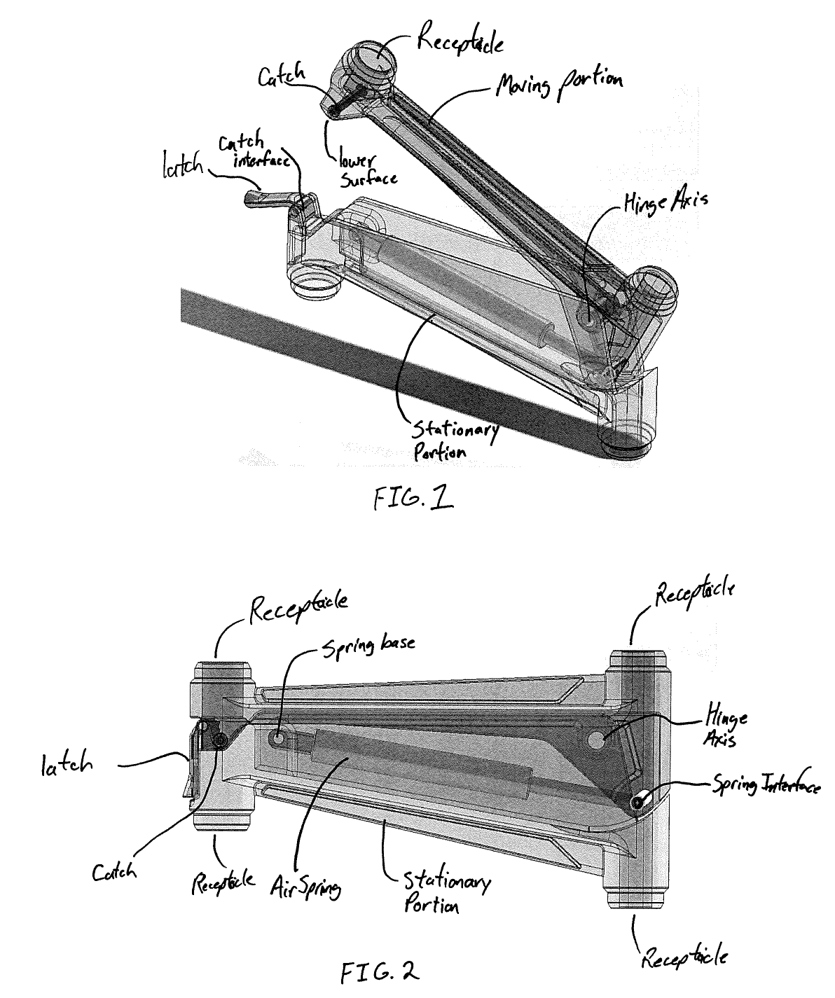

FIG. 1 is a right, front, elevation view of a modular hinge.

FIG. 2 is a right side plan view of the hinge of FIG. 1.

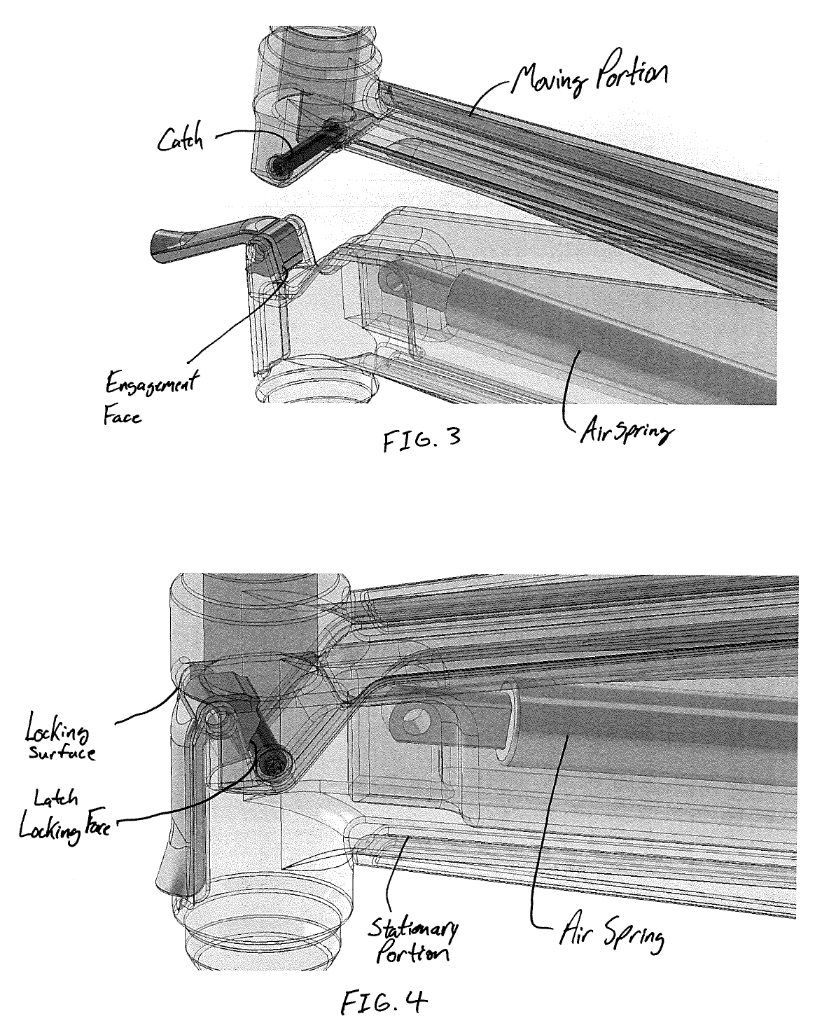

FIG. 3 1 is a right, front, elevation view of the hinge of FIG. 1.

FIG. 4 is a right, rear, elevation view of the hinge of FIG. 1.

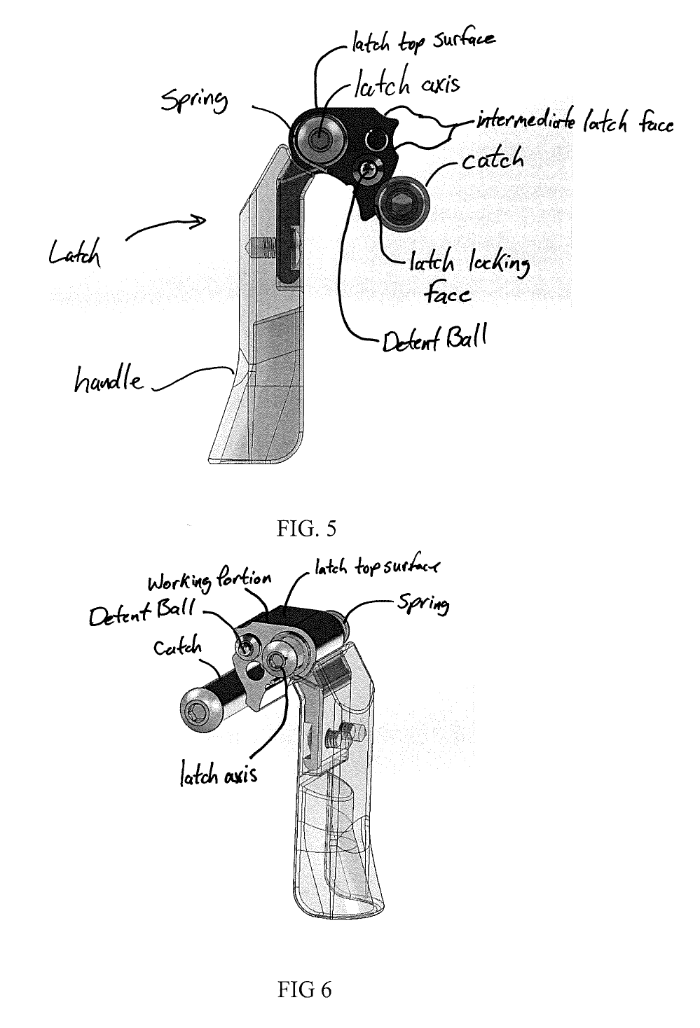

FIG. 5 is a detail right side elevation view of a latch and catch suitable for use in the modular hinge of FIG. 1.

FIG. 6 is a left, rear, elevation view of the latch and catch of FIG. 5.

### DETAILED DESCRIPTION

The present disclosure is related to an improved hinge mechanism specifically for use with boat towers. In particular, the hinge provides an improved mechanism by which boat tower, such as a wake board tower, may be divided into two portions, the upper portion being pivotally coupled to a lower portions that is fixedly coupled to the boat. Such towers may be constructed of round metal tubing, however, other materials may be used. It should be noted that in referring to “towers” the present disclosure contemplates a variety of structures configured to extend upwardly from the other structures of a boat. These may include Bimini covers, T-Tops, and other such structures in addition to wake board towers.

Referring to the drawings, a hinge generally includes a stationary portion and a moving portion. The stationary portion may include one or more receptacles for coupling to the lower, fixed portion of the tower. As shown in the figure, a stationary portion may include two such receptacles. The moving portion may be pivotally coupled to the stationary portion at a hinge axis by a pin, busing, or other such fastener. The moving portion similarly includes one or more receptacles for coupling to the structure of the upper portion of the tower.

Positioned within the stationary portion is an assisting device such as the air spring shown. Alternatively, a motorized screw, actuator, hydraulic piston, coil spring, or other such device may be used to assist a user moving the top portion of the tower. The air spring is shown as being pivotally coupled to the stationary portion at a fixed (relative to the stationary portion) spring base and extends to a spring interface on the moving portion.

As shown in the figures, the moving portion may include a catch, shown as a cylindrical rod configured to interface with a latch in the stationary portion. This configuration can be reversed. The latch shown includes a lever that rests along the hinge structure when locked and may be unlocked by lifting or pulling it by a user. The latch may include a latch locking face configured to interface with a surface of the catch when the hinge is locked in the closed position.

The weight of the tower may, as previously noted, be offset with an assisting device such as the air spring. Additionally, the weight of the tower may be used to actuate a self-locking feature of the latch. In such embodiments, the moving portion may have a locking surface that interfaces with the latch at a point prior to complete closure of the latch. As the hinge continues to close, the latch is pushed to the locked portion and may be configured such that the weight of the moving portion of the tower is sufficient to complete this process.

In some embodiments, the latch or air spring may be adjusted to require manual operation of the latch to lock the hinge. This can be an added safety feature as it requires the user to verify the latch is locked.

In use, typically two of the disclosed hinges will be used in conjunction, one on the port side of the tower, and one on the starboard side of the tower. When unlocked, the hinges may allow the upper portion of the tower to be rotated toward the bow of the boat. This lowers the clearance height required for the boat and increased options for docking and storage of the boat.

Referring to FIGS. 5 and 6, the latch and catch are shown in the closed position with the latch being a two-part component having a handle and a working portion. This configuration allows universal working portions to be utilized across a line of products with only the handle needing to be designed to conform to the aesthetic or a particular product. In use, a user may lift the handle and release the catch from the latch and allow the upper portion of the tower to be pivoted about the hinge.

To place the upper portion of the tower in an erect position, a user rotates the upper portion of the tower about the hinge until the catch contacts the latch top surface. As the weight of the tower pushes downward, the latch pivots outward about the latch axis such that the catch may continue travelling downward through an arc centered about the hinge. As it progresses through the arc, the catch may come into contact with one or more intermediate latch faces. As the catch transitions from one intermediate latch face to the next, the latch will pivot partially to the closed and locked position (i.e. the handle being pointed down). At the end of its travel arc, the catch will engage the latch locking face. The latch is biased towards the closed and locked position by one or more springs shown as coil springs about the latch axis. Other features may be provided such as a detent ball that may engage a detent in the tower structure or hinge to keep the latch in an open position.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description herein is for the purpose of describing particular embodiments only and is not intended to be limiting of the invention. As used in the description of the embodiments and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims.

What is claimed is:

1. A boat tower having a lower portion fixed to a boat, an upper portion pivotally coupled to the lower portion, and a hinge configured to couple the upper portion to the lower portion wherein the hinge comprises:
a stationary portion coupled to the lower portion of the tower;
a moving portion coupled to the lower portion at a hinge axis;
an assisting device extending from a position fixed on the stationary portion to an interface on the moving portion;
a catch coupled to the moving portion;
a latch coupled to the stationary portion configured to interface with the catch thereby locking the hinge in a closed position; and
wherein the latch is configured to move to a locked position by the moving portion moving into the closed position and the weight of the upper portion of the tower provides sufficient force to engage and lock the latch.
